(19) United States
(12) Patent Application Publication
(10) Pub. No.: US 2011/0025824 A1
(43) Pub. Date: Feb. 3, 2011

(54) MULTIPLE EYE PHOTOGRAPHY METHOD AND APPARATUS, AND PROGRAM

(75) Inventors: Yoshiaki KATO, Kurokawa-gun (JP); Toshinori Miyamura, Kurokawa-gun (JP); Akihiko Shimeno, Kurokawa-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/841,925

(22) Filed: Jul. 22, 2010

(30) Foreign Application Priority Data
Jul. 31, 2009 (JP) 179623/2009

(51) Int. Cl. H04N 13/02; G03B 35/00

(52) U.S. Cl. 348/46; 396/326; 348/E13.074

(57) ABSTRACT

First macro photography is performed with each of the imaging systems being focused on a main subject to obtain first images, second photography is performed with one of the plurality of imaging systems being focused on a position farther away than the main subject to obtain a second image, processing is performed on each of the first images to transparentize an area other than the main subject, and each of the transparentized first images and an area other than the main subject of the second image are combined to generate a combined image corresponding to each of the imaging systems.

### BACKGROUND OF THE INVENTION

1. Field of the Invention

The present invention relates to a multiple eye photography method and apparatus for photographing a subject using a plurality of imaging systems to obtain images having a parallax between each image in order to, for example, generate a stereoscopic image. The invention also relates to a computer readable recording medium on which is recorded a program for causing a computer to perform the method.

2. Description of the Related Art

It has been known that a stereoscopically viewable image can be created using parallax by displaying a plurality of images in a combined manner. Such a stereoscopically viewable image (stereoscopic image) is generated based on a plurality of images having a parallax between each image obtained by imaging the same subject from different positions using a plurality of cameras.

More specifically, a stereoscopic image can be generated, for example, by superimposing a plurality of images using different colors or with polarization in different directions. Further, a method of generating a stereoscopic image by displaying a plurality of images on a stereoscopically viewable 3D liquid crystal, such as parallax barrier technology or lenticular technology, is also proposed.

Generation of a stereoscopic image based on images having a parallax between each image described above, however, has problems that the method requires a complicated structure because it requires a lenticular lens or a spatial light modulator and causes a viewer to feel the stereoscopic image unnatural and increased tiredness since the viewer can not make a distance judgment by the eye focus. In order to solve these problems, Japanese Unexamined Patent Publication Nos. 2006-267767 and 2002-341472 propose, instead of generating a stereoscopic image by obtaining a plurality of images having a parallax between each image described above, a method of generating a stereoscopically viewable image by, for example, obtaining a plurality of sets of image data by imaging subjects, each in focused state, at different distances, and displaying the plurality of sets of image data on different display panels and superimposing them.

The superimposition of images obtained by focusing a near view, a middle view, and a distant view respectively, as in the invention disclosed in Japanese Unexamined Patent Publication Nos. 2006-267767 and 2002-341472, is merely the superimposition of two-dimensional images and causes a viewer to feel uncomfortable in comparison with a stereoscopic image generated based on a plurality of images having a parallax between each image.

Further, the method described in Japanese Unexamined Patent Publication Nos. 2006-267767 and 2002-341472 requires a special display device for displaying a plurality of images in a superimposing manner, resulting in an increased cost and complicated structure.

In the mean time, in the multiple eye photography method for obtaining a plurality of images having a parallax between each image described above, macro photography, in which a main subject is photographed in proximity, may sometimes be performed.

In conventional multiple eye photography methods, however, if such macro photography is performed, the convergence angle between each of a plurality of cameras becomes large and the positional difference of a so-called background image at the back of the main subject is increased between each of a plurality of images, whereby the background images become reverse phase to each other and the plurality of background images do not correspond to each other when viewed stereoscopically.

One method of solving such reverse phase problem of background images is to use only a corresponding portion between background images but, in such a case, a stereoscopic image having full of stereoscopic effect can not be generated since only a portion of the background images is used.

If the convergence angle between each of the plurality of cameras is reduced, the so-called reverse phase problem may be solved, but the convergence angle can not be reduced only in macro imaging because the sizes of the taking lenses are physically fixed. For example, Japanese Unexamined Patent Publication No. 10 (1998)-039435 proposes a method in which, in addition to ordinary taking lenses, a mechanism for changing the convergence angle is provided for changing the convergence angle according to the camera-to-subject distance. But such method requires a mechanism for changing the convergence angle, resulting in increased size and cost.

The present invention has been developed in view of the circumstances described above and it is an object of the present invention to provide a multiple eye photography method and apparatus capable of easily obtaining a stereoscopic image that does not give uncomfortable feeling due to reverse phase of background images even in macro photography. It is a further object of the present invention to provide a computer readable recording medium on which is recorded a program for causing a computer to perform the method described above.

### SUMMARY OF THE INVENTION

A multiple eye photography method of the present invention is a method for use when macro photography is performed by a multiple eye photography apparatus having a plurality of imaging systems, the method including the steps of:

performing first macro photography with each of the imaging systems being focused on a main subject to obtain first images;

performing second photography with one of the plurality of imaging systems being focused on a position farther away than the main subject to obtain a second image;

performing processing on each of the first images to transparentize an area other than the main subject; and

combining each of the transparentized first images and an area other than the main subject of the second image to generate a combined image corresponding to each of the imaging systems.

Another multiple eye photography method of the present invention is a method for use when macro photography is performed by a multiple eye photography apparatus having a plurality of imaging systems, the method including the steps of:

performing first macro photography with each of the imaging systems being focused on a main subject to obtain first images;

obtaining, as a second image, one of images obtained through second photography performed with each of the plurality of imaging systems being focused on a position farther away than the main subject;

performing processing on each of the first images to transparentize an area other than the main subject; and

combining each of the transparentized images and an area other than the main subject of the second image to generate a combined image corresponding to each of the imaging systems.

A still another multiple eye photography method of the present invention is a method for use when macro photography is performed by a multiple eye photography apparatus having a plurality of imaging systems, the method including the steps of:

performing first macro photography with each of the imaging systems being focused on a main subject to obtain first images;

performing second photography with each of the plurality of imaging systems being focused on a position farther away than the main subject to obtain second images;

performing processing on each of the first images for transparentizing an area other than the main subject; and

combining each of the transparentized images and an area other than the main subject of each of the second images corresponding to each of the first images to generate a combined image corresponding to each of the imaging systems.

In each of the multiple eye photography methods described above, when discrimination between a predetermined area, including the main subject, and an area other than the predetermined area within the photograph range of each of the imaging systems is difficult, the first macro photography may be performed by emitting a flash to obtain the first images.

Further, an arrangement may be adopted in which a luminance value distribution of a predetermined area, including the main subject, and a luminance value distribution of an area other than the predetermined area of the photograph range of each of the imaging systems are detected and, if the difference between the distributions is greater than or equal to a threshold value, the first macro photography is performed without emitting a flash, while, if the difference between the distributions is smaller than the threshold value, the first macro photography is performed by emitting a flash.

Still further, an arrangement may be adopted in which a hue value distribution of a predetermined area, including the main subject, and a hue value distribution of an area other than the predetermined area within a photograph range of each of the imaging systems are detected and, if the difference between the distributions is greater than or equal to a threshold value, the first macro photography is performed only without a flash, while, if the difference between the distributions is smaller than the threshold value, the first macro photography is performed with and without a flash, selection of either one of the first images obtained by the first macro photography with and without a flash is accepted, the selected first image is subjected to transparentizing processing, and the combined image is generated using the transparentized first image and the second image.

A multiple eye photography apparatus of the present invention is an apparatus, including:

a plurality of imaging systems;

an imaging system controller for controlling each of the imaging systems to perform first macro photography with each of the imaging systems being focused on a main subject and to perform second photography with one of the plurality of imaging systems being focused on a position farther away than the main subject;

a transparentizing processing unit for performing processing on each of first images obtained by each of the imaging systems through the first macro photography for transparentizing an area other than the main subject; and

a combined image generation unit for combining each of the transparentized first images transparentized by the transparentizing processing unit and an area other than the main subject of the second image to generate a combined image corresponding to each of the imaging systems.

Another multiple eye photography apparatus of the present invention is an apparatus, including:

a plurality of imaging systems;

an imaging system controller for controlling each of the imaging systems to perform first macro photography with each of the imaging systems being focused on a main subject and to perform second photography with each of the imaging systems being focused on a position farther away than the main subject;

a transparentizing processing unit for performing processing on each of first images obtained by each of the imaging systems through the first macro photography to transparentize an area other than the main subject; and

a combined image generation unit for combining each of the transparentized first images transparentized by the transparentizing processing unit and an area other than the main subject of a second image which is one of the images obtained by each of the imaging systems through the second photography to generate a combined image corresponding to each of the imaging systems.

A still another multiple eye photography apparatus of the present invention is an apparatus including:

a plurality of imaging systems,

an imaging system controller for controlling each of the imaging systems to perform first macro photography with each of the imaging systems being focused on a main subject and to perform second photography with each of the imaging systems being focused on a position farther away than the main subject;

a transparentizing processing unit for performing processing on each of first images obtained by each of the imaging systems through the first macro photography to transparentize an area other than the main subject; and

a combined image generation unit for combining each of the transparentized first images transparentized by the transparentizing processing unit and an area other than the main subject of each of second images, corresponding to each of the first images, obtained by each of the imaging systems through the second photography to generate a combined image corresponding to each of the imaging systems.

Each of the multiple eye photography apparatuses described above may include a flash controller for emitting a flash when discrimination between a predetermined area, including the main subject, and an area other than the predetermined area within a photograph range of each of the imaging systems is difficult at the time of the first macro photography.

Further, each of the apparatuses may further include a luminance distribution detection unit for detecting a luminance value distribution of the predetermined area, including the main subject, and a luminance value distribution of the area other than the predetermined area within the photograph range of each of the imaging systems, and a flash controller that, when the first macro photography is performed, does not emit a flash if the difference between the distributions is greater than or equal to a threshold value and emits a flash if the difference between the distributions is smaller than the threshold value.

Still further, each of the apparatuses may further include a hue distribution detection unit for detecting a hue value distribution of a predetermined area, including the main subject, and a hue value distribution of an area other than the predetermined area within a photograph range of each of the imaging systems and a photography & processing controller for performing control such that: if the difference between the distributions is greater than or equal to a threshold value, the first macro photography is performed only without a flash; while, if the difference between the distributions is smaller than the threshold value, the first macro photography is performed with and without a flash, selection of either one of the first images obtained by the first macro photography with and without a flash is accepted, the selected first image is subjected to the transparentizing processing, and the combined image is generated using the transparentized first image and the second image.

A computer readable recording medium of the present invention is a medium on which is recorded a program for causing a computer to perform a multiple eye photography method for use when macro photography is performed by a multiple eye photography apparatus, the method including the steps of:

performing first macro photography with each of the imaging systems being focused on a main subject to obtain first images;

performing second photography with one of the plurality of imaging systems being focused on a position farther away than the main subject to obtain a second image;

performing processing on each of the first images to transparentize an area other than the main subject; and

combining each of the transparentized first images and an area other than the main subject of the second image to generate a combined image corresponding to each of the imaging systems.

Another computer readable recording medium of the present invention is a medium on which is recorded a program for causing a computer to perform a multiple eye photography method for use when macro photography is performed by a multiple eye photography apparatus, the method including the steps of:

performing first macro photography with each of the imaging systems being focused on a main subject to obtain first images;

obtaining, as a second image, one of images obtained through second photography performed with each of the plurality of imaging systems being focused on a position farther away than the main subject;

performing processing on each of the first images to transparentize an area other than the main subject; and

combining each of the transparentized images and an area other than the main subject of the second image to generate a combined image corresponding to each of the imaging systems.

A still another computer readable recording medium of the present invention is a medium on which is recorded a program for causing a computer to perform a multiple eye photography method for use when macro photography is performed by a multiple eye photography apparatus, the method including the steps of:

performing first macro photography with each of the imaging systems being focused on a main subject to obtain first images;

performing second photography with each of the plurality of imaging systems being focused on a position farther away than the main subject to obtain second images;

performing processing on each of the first images for transparentizing an area other than the main subject; and

combining each of the transparentized images and an area other than the main subject of each of the second images corresponding to each of the first images to generate a combined image corresponding to each of the imaging systems.

The term “macro photography” as used herein refers to close-up photography performed with a distance not greater than 50 cm between the imaging system and main subject.

Further, the phrase “when discrimination between a predetermined area, including the main subject, and an area other than the predetermined area within a photograph range of each of the imaging systems is difficult” as used herein refers to the case in which discrimination between the area, including the main subject, and the area other than the predetermined area is impossible or the case in which the discrimination is possible but with low accuracy.

According to the multiple eye photography methods and apparatuses, and the computer readable recording media of the present invention, first macro photography is performed with the focus being on a main subject to obtain first images, and second photography is performed with the focus being on a position farther away than the main subject to obtain a second image, processing is performed on each of the first images to transparentize an area other than the main subject, and each of the transparentized first images and an area other than the main subject of the second image are combined to generate a combined image corresponding to each of the imaging systems. This may eliminate or reduce the influence of the reverse phase of background images described above. That is, an image farther than the main subject is photographed in the second photography, which means that the second photography is performed with a convergence angle smaller than that of the first photography, so that the reverse phase of background images in photographed images is eliminated or reduced.

In the multiple eye photography methods and apparatuses, and the computer readable recording media of the present invention, if an arrangement is adopted in which a luminance value distribution of a predetermined area, including the main subject, and a luminance value distribution of an area other than the predetermined area within a photograph range of each of the imaging systems are detected and, if the difference between the distributions is greater than or equal to a threshold value, the first macro photography is performed without emitting a flash to obtain the first images, while if the difference between the distributions is smaller than the threshold value, the first macro photography is performed by emitting a flash to obtain the first images, the luminance of the main subject in photographed images is increased and the area of the main subject may be detected more reliably in the processing of transparentizing an area other than the main subject.

Further, if an arrangement is adopted in which a hue value distribution of a predetermined area, including the main subject, and a hue value distribution of an area other than the predetermined area within a photograph range of each of the imaging systems are detected and, if the difference between the distributions is greater than or equal to a threshold value, the first macro photography is performed only without a flash, while, if the difference between the distributions is smaller than the threshold value, the first macro photography is performed with and without a flash, selection of either one of the first images obtained by the first macro photography with and without a flash is accepted, the selected first image is subjected to transparentizing processing, and the combined image is generated using the transparentized first image and the second image, unnecessary performance of the second photography, transparentizing processing, and combining processing may be avoided. That is, if the difference between the hue value distributions is greater than or equal to a threshold value, it can be normally regarded that the main subject is present over the entire photograph range. In such a case, no background image is present and hence the reverse phase of background images does not occur. Therefore, the performance of the first photography of ordinary macro photography is sufficient and the processing may be speeded up by skipping the performance of the second photography, transparentizing processing, and combining processing.

### BRIEF DESCRIPTION OF THE DRAWINGS

FIG. 1 is a perspective view of a digital camera according to first to third embodiments, illustrating a front view thereof.

FIG. 2 is a perspective view of the digital camera shown in FIG. 1, illustrating a rear view thereof.

FIG. 3 is a block diagram of the digital camera shown in FIG. 1, illustrating an electrical configuration thereof.

FIG. 4 is a flowchart illustrating a flow of stereo macro photography performed by the digital camera according to the first embodiment of the present invention.

FIG. 5 is a schematic view of an example subject displayed on the digital camera.

FIG. 6 is a schematic view of an example of imaging scene.

FIG. 7 is a schematic view of an example of left eye image photographed in Macro Mode.

FIG. 8 is a schematic view of an example of right eye image photographed in Macro Mode.

FIG. 9 is a schematic view of an example of left eye image after subjected to transparentizing processing.

FIG. 10 is a schematic view of an example of right eye image after subjected to transparentizing processing.

FIG. 11 is a schematic view of an example of left eye or right eye image with a main subject being out of focus.

FIG. 12 is a schematic view of an example of combined left eye image.

FIG. 13 is a schematic view of an example of combined right eye image.

FIG. 14 illustrates an example of recording format of image file recorded in a digital camera.

FIG. 15 illustrates an example of another recording format of the image file.

FIG. 16 is a flowchart illustrating a flow of stereo macro photography performed by the digital camera according to the second embodiment of the present invention.

FIG. 17 illustrates an example image of imaged scene including substantially only a near view.

FIG. 18A is a flowchart illustrating a flow of stereo macro photography performed by the digital camera according to the third embodiment of the present invention (part 1).

FIG. 18B is a flowchart illustrating a flow of stereo macro photography performed by the digital camera according to the third embodiment of the present invention (part 2).

FIG. 19 illustrates another example image of imaged scene including substantially only a near view.

FIG. 20 illustrates an example of selection screen between an in-focus image taken with a flash and an in-focus image taken without a flash.

### DESCRIPTION OF THE PREFERRED EMBODIMENTS

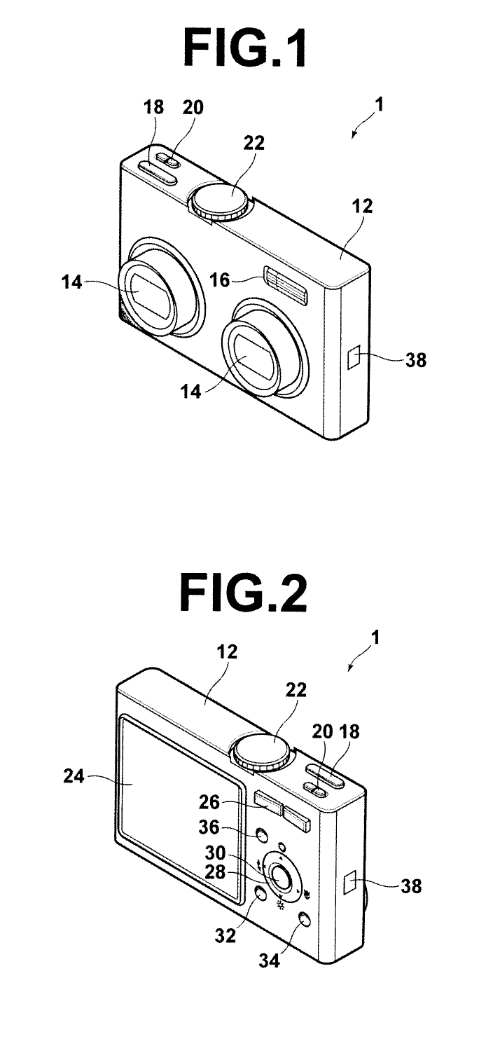

Hereinafter, a digital camera that incorporates a first embodiment of the present invention will be described in detail with reference to the accompanying drawings. FIGS. 1 and 2 respectively illustrate front and rear views of digital camera 1 that incorporates a first embodiment of the multiple eye photography apparatus of the present invention.

Camera body 12 of digital camera 1 is foamed substantially in a rectangular box, and two taking lenses 14, 14, flash 16, and the like are provided on the front side as shown in FIG. 1. SHUTTER button 18, POWER/MODE switch 20, MODE dial 22, and the like are provided on the upper side of camera body 12.

As shown in FIG. 2, monitor 24, ZOOM button 26, ARROW button 28, MENU/OK button 30, DISP button 32, BACK button 34, MACRO button 36, and the like are provided on the rear side of camera body 12. Further, input/output connector 38 is provided on a side of camera body 12.

Although not shown, a tripod screw hole, an openable/closable battery cover, and the like are provided on the bottom side of camera body 12. A battery receiving chamber for receiving a battery and a memory card slot for inserting a memory card are provided inside of the battery cover.

Taking lenses 14, 14 constitute a part of a right imaging system and a part of a left imaging system respectively, to be described later. Each of taking lenses 14, 14 is formed of a retractable zoom lens and has a macro imaging function (proximity imaging function). When power of digital camera 1 is turned ON, taking lenses 14, 14 stick out from camera body 12. Known mechanisms are applied to the zoom mechanism, retracting mechanism, and macro imaging mechanism of each taking lens 14 and, therefore, they are not elaborated upon further here.

Flash 16 includes a xenon lamp and light is emitted as required when a dark subject is imaged or in a backlight condition.

SHUTTER button 18 is constituted by a two-step stroke type switch in which so-called “halfway depression” and “full depression” provide different functions. Digital camera 1 is configured such that, when SHUTTER button 18 is depressed halfway when Still Image Photography Mode is selected by MODE dial 22 or through MENU, preparatory processing for photography, such as AE (automatic exposure) processing, AF (auto focus) processing, and AWB (automatic white balance) processing are performed, and then if SHUTTER button is depressed fully, image taking/recording processing is performed. Note that digital camera 1 may be provided with a moving picture photography function as appropriate, but this is not directly related to the present invention and, therefore, not elaborated upon further here.

POWER/MODE switch 20 functions as a power switch of digital camera 1 and as a switch for switching between Reproduction Mode and Photography Mode and formed slidably movable among “OFF position”, “REPRODUCTION position”, and “PHOTOGRAPHY position”. When POWER/MODE switch 20 is set to the following positions, the following are performed: digital camera 1 is set to Reproduction Mode if is set to “REPRODUCTION position”; digital camera 1 is set to Photography Mode if set to “PHOTOGRAPHY position”, and power of digital camera is turned OFF if set to “OFF position”.

MODE dial 22 is used for selecting a photography mode. MODE dial 22 is rotatably provided on the upper side of camera body 12 and settable, for example, to “2D STILL IMAGE position”, “2D MOVING PICTURE position”, “3D STILL IMAGE position”, and “3D MOVING PICTURE position” by a not shown click mechanism. When MODE dial 22 is set to “2D STILL IMAGE position”, digital camera 1 is set to 2D Still Image Photography Mode for photographing a 2D, i.e., general two-dimensional still image, and a flag that indicates that 2D Still Image Photography Mode is set in 2D/3D mode switching flag unit 168, to be described later. If MODE dial 22 is set to “2D MOVING PICTURE position”, digital camera 1 is set to 2D Moving Picture Photography Mode for photographing a 2D moving picture and a flag that indicates that 2D Moving Picture Photography Mode is set in 2D/3D mode switching flag unit 168.

When MODE dial 22 is set to “3D STILL IMAGE position”, digital camera 1 is set to 3D Still Image Photography Mode for photographing a 3D, i.e., general three-dimensional still image and a flag that indicates that 3D Still Image Photography Mode is set in 2D/3D mode switching flag unit 168. If MODE dial 22 is set to “3D MOVING PICTURE position”, digital camera 1 is set to 3D Moving Picture Photography Mode for photographing a 3D moving picture and a flag that indicates 3D moving picture photography mode is set in 2D/3D mode switching flag unit 168.

CPU 110, to be described later, figures out which one of 2D Still Image Photography Mode, 2D Moving Picture Photography Mode, 3D Still Image Photography Mode, and 3D Moving Picture Photography Mode is selected by referring to the flag in 2D/3D mode switching flag unit 168.

3D Still Image Photography Mode or 3D Moving Picture Photography Mode herein refers to a mode in which two types of images having a parallax between them are photographed by a right imaging system that includes one of taking lenses 14, 14 and a left imaging system that includes the other of taking lenses 14, 14. The two images photographed in this mode are three-dimensionally displayed on monitor 24. Here, any known method may be used for the three dimensional display. For example, a method that implements stereoscopic display by displaying two images side by side and based on naked eye parallel viewing or a lenticular method that realizes three-dimensional display by attaching lenticular lenses to monitor 24 and displaying each image at a predetermined position of the display screen of monitor 24 so that each image is viewed by both eyes of a viewer may be used. Further, an anaglyph method that realizes three-dimensional display by superimposing two images using different colors, for example, red and blue or with polarization in different directions may also be used. Still further, a scan backlight method that realizes three-dimensional display by alternately dividing the optical path of the backlight of monitor 24 so as to optically correspond to left and right eyes and alternately displaying two images on the display screen of monitor 24 according to the division of the backlight in the left-right direction may also be employed. As an example, monitor 24 includes an image display device such as a color liquid crystal display or the like. Monitor 24 is used as a GUI for various setting operations, as well as used as an image display unit for displaying a photographed image. In addition, when photography is performed, an image captured by an image sensor is through-displayed on monitor 24, whereby the monitor is used as an electronic finder. Note that monitor 24 is assumed, here, to have been modified according to any one of the three-dimensional display methods described above. For example, if the three-dimensional display method is the lenticular method, lenticular lenses are attached to the display screen of monitor 24, while if the three-dimensional display method is the scan backlight method, an optical device for changing light beams of left and right images is attached to the display screen of monitor 24.

ZOOM button 26 is used for changing the zoom magnification setting and includes ZOOM TELE button for instructing zooming to the telephoto side and ZOOM WIDE button for instructing zooming to the wide angle side.

ARROW button 28 is provided depressably in four directions of up, down, left, and right. A function according to setting status of the camera is allocated to the button in each direction. For example, when photography is performed, a function to select ON or OFF of a macro function is allocated to the left button and a function to select Flash Mode is allocated to the right button. Further, a function to change the brightness of monitor 24 is allocated to the upper button and a function to select ON or OFF of a self-timer is allocated to the lower button. When image reproduction is performed, a frame advance function is allocated to the left button, while a frame return function is allocated to the right button. Further, a function to change the brightness of monitor 24 is allocated to the upper button and a function to delete a reproduced image is allocated to the lower button. Further, when various setting operations are performed, each button is allocated a function to move a cursor displayed on monitor 24 in each direction, and one of a plurality of images displayed on monitor 24 can be selected by moving the cursor.

MENU/OK button 30 is used for calling up a menu screen (MENU function), fixing the selection, and instructing the execution of the processing (OK function), and a function to be allocated is changed according to the setting status of digital camera 1. In the menu screen described above, all adjustment items of digital camera 1 are set, including image quality adjustments, such as exposure value, color shade, ISO speed, and film valid pixels, self-timer setting, selection of photometric method, use of digital zoom, and the like. Digital camera 1 operates according to the conditions set on the menu screen.

DISP button 32 is used for inputting an instruction to switch display contents of monitor 24 and the like and BACK button 34 is used for inputting an instruction to cancel an inputted operation instruction.

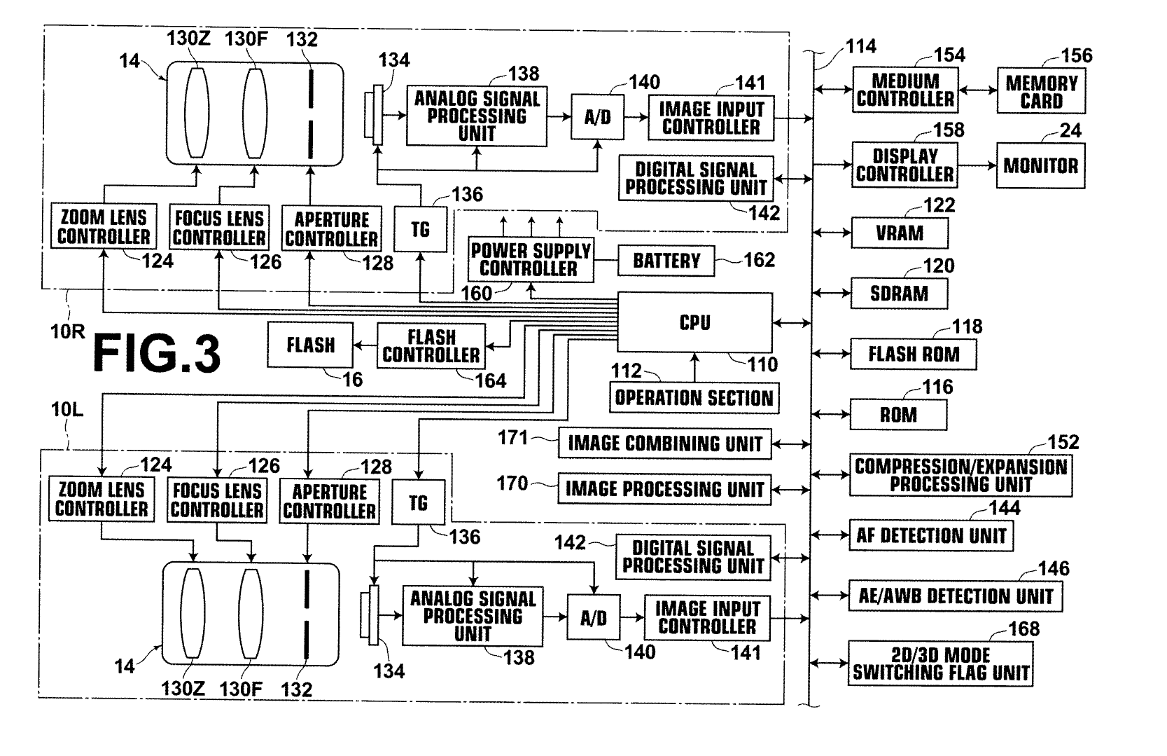

FIG. 3 is a block diagram of digital camera 1, illustrating mainly an electrical configuration thereof. Hereinafter, the electrical configuration of digital camera 1 will be described with reference to FIG. 3. Note that elements shown in FIGS. 1 and 2 are also described as appropriate in relation to other elements.

As shown in FIG. 3, digital camera 1 includes CPU 110, operation section 112 (aforementioned SHUTTER button 18, POWER/MODE switch 20, MODE dial 22, ZOOM button 26, ARROW button 28, MENU/OK button 30, DISP button 32, BACK button 34, MACRO button 36, and the like), ROM 116, flash ROM 118, SDRAM 120, VRAM 122, AF detection unit 144, AE/AWB detection unit 146, compression/expansion processing unit 152, medium controller 154, memory card 156, display controller 158, monitor 24, power supply controller 160, battery 162, flash controller 164, flash 16, 2D/3D mode switching flag unit 168, image processing unit 170, and image combining unit 171.

Digital camera 1 further includes right imaging system 10R and left imaging system 10L. These imaging systems basically have an identical configuration. Each imaging system includes taking lens 14, zoom lens controller 124, focus lens controller 126, aperture controller 128, image sensor 134, timing generator (TG) 136, analog signal processing unit 138, A/D converter 140, image input controller 141, and digital signal processing unit 142.

CPU 110 functions as a controller for controlling the operation of the entire camera, and controls each unit according to a predetermined program based on input from the operation section 112. Control programs to be executed by CPU 110 and various data (AE/AF control data and the like) required for control, and the like are stored in ROM 116 connected to CPU 110 through bus 114, and various set information related to the operation of digital camera 1, such as user set information, is stored in flash ROM 118.

SDRAM 120 is used as a calculation work area of CPU 110 and as a temporary storage area for image data. VRAM 122 is used as a dedicated temporary storage area for display image data.

Taking lens 14 includes zoom lens 130Z, focus lens 130F, and aperture 132. Zoom lens 130Z is driven by a not shown zoom actuator and moves back and forth along the optical axis. CPU 110 controls the position of zoom lens 130Z by controlling the zoom actuator via zoom lens controller 124 and controls zooming, i.e., a zoom magnification change operation of taking lens 14.

Focus lens 130F is also driven by a not shown focus actuator and moves back and forth along the optical axis. CPU 110 controls the position of focus lens 130F by controlling the focus actuator via focus lens controller 126 and controls the focusing of taking lens 14.

Aperture 132 is driven by a not shown aperture actuator. CPU 110 controls the aperture amount (aperture value) of aperture 132 by controlling the aperture actuator via aperture controller 128 and control the amount of light incident on image sensor 134.

Image sensor 134 includes a CCD having a predefined color filter array. The CCD has multiple photodiodes arranged two-dimensionally on the light receiving surface thereof. An optical image of a subject formed on the light receiving surface of the CCD by taking lens 14 is converted to signal charges by the photodiodes according to the amount of incident light. The signal charge stored in each photodiode is sequentially read out as a voltage signal (image signal), which is in proportion to the amount of signal charge, based on the drive pulse supplied from TG 136 in response to the instruction from CPU 110. Image sensor 134 has a so-called electronic shutter function and the exposure time (shutter speed) is controlled by controlling the charge storage time in the photodiodes.

Although a CCD is used as image sensor 134 in the present embodiment, other types of image sensors, such as a CMOS sensor, may also be used.

Analog signal processing unit 138 includes a correlated double sampling circuit (CDS) for removing reset noise (low frequency) in an image signal outputted from image sensor 134, an AGC circuit for amplifying and controlling an image signal to a certain constant level, and the like, and amplifies an image signal outputted from image sensor 134.

A/D converter 140 converts an analog image signal outputted from analog signal processing unit to a digital image signal. Image input controller 141 captures and stores a digital image signal outputted from A/D converter 140 in SDRAM 120.

In response to an instruction from CPU 110, digital signal processing unit 142 retrieves an image signal stored in SDRAM 120 and generates a YUV signal constituted by a luminance signal Y and color difference signals Cr, Cb by performing predetermined signal processing on the retrieved image data. Further, digital signal processing unit 142 performs calculation of a gain value for white balance adjustment by receiving an integrated value calculated in AE/AWB detection unit 146, offset processing for each of image signals of R, G, and B taken in via image input controller 141, gamma correction processing, noise reduction processing, and the like.

AF detection unit 144 receives each of R, G, B color image signals from image input controller 141 and calculates a focus evaluation value necessary for AF control and outputs the calculated value to CPU 110. CPU 110 searches for a position where the focus evaluation value becomes maximal and moves focus lens 130F to the position to focus on a main subject.

AE/AWB detection unit 146 receives each of R, G, B color image signals from image input controller 141 and calculates an integrated value necessary for AE and AWB control. At the time of AE control, CPU 110 obtains each of integrated values of R, G, B signals calculated in AE/AWB detection unit 146 with respect to each area within the field to calculate the brightness of the subject (photometric value), thereby performing exposure setting, i.e., sensitivity, aperture value, shutter speed, with/without flash, and the like, for obtaining an appropriate amount of exposure.

At the time of AWB control, CPU 110 inputs each of integrated values of R, G, B signals calculated in AE/AWB detection unit 146 with respect to each area within the field to digital signal processing unit 142 so as to be used for white balance adjustment and detection of the type of light source.

Compression/expansion processing unit 152 performs, in response to an instruction from CPU 110, compression processing of a predetermined format on inputted image data to generate compressed image data. Further, the unit performs, in response to an instruction from CPU 110, expansion processing of a predetermined format on inputted image data to generate non-compressed image data.

Medium controller 154 performs data read/write control with respect to memory card 156 in response to an instruction from CPU 110.

Display controller 158 performs display control on monitor 24 in response to an instruction from CPU 110. That is, in response to an instruction from CPU 110, display controller 158 converts an inputted image signal to a video signal for displaying on monitor 24 (e.g., NTSC, PAL, or SECAM signal) and outputs the video signal and prescribed character/graphical information to monitor 24.

Power supply controller 160 performs power supply control from battery 162 to each unit in response to an instruction from CPU 110. Flash controller 164 performs emission control of flash 16 in response to an instruction from CPU 110.

Image processing unit 170 performs image processing according to the present invention, to be described later. Image combining unit 171 combines in-focus and out-of-focus image data according to the present invention, to be described later, and the unit may be in the form of a circuit or a computer program that performs image composition.

In the present embodiment, CPU 110 constitutes a photography system controller, a flash controller, a luminance distribution detection unit, a hue distribution detection unit, and a photography & processing controller.

When a subject is photographed by right imaging system 10R and left imaging system 10L, images having a parallax between them are photographed by the respective imaging systems. Use of digital image signals representing such images allows, for example, a stereoscopic image to be generated or three-dimensional position information of a measuring target object to be obtained.

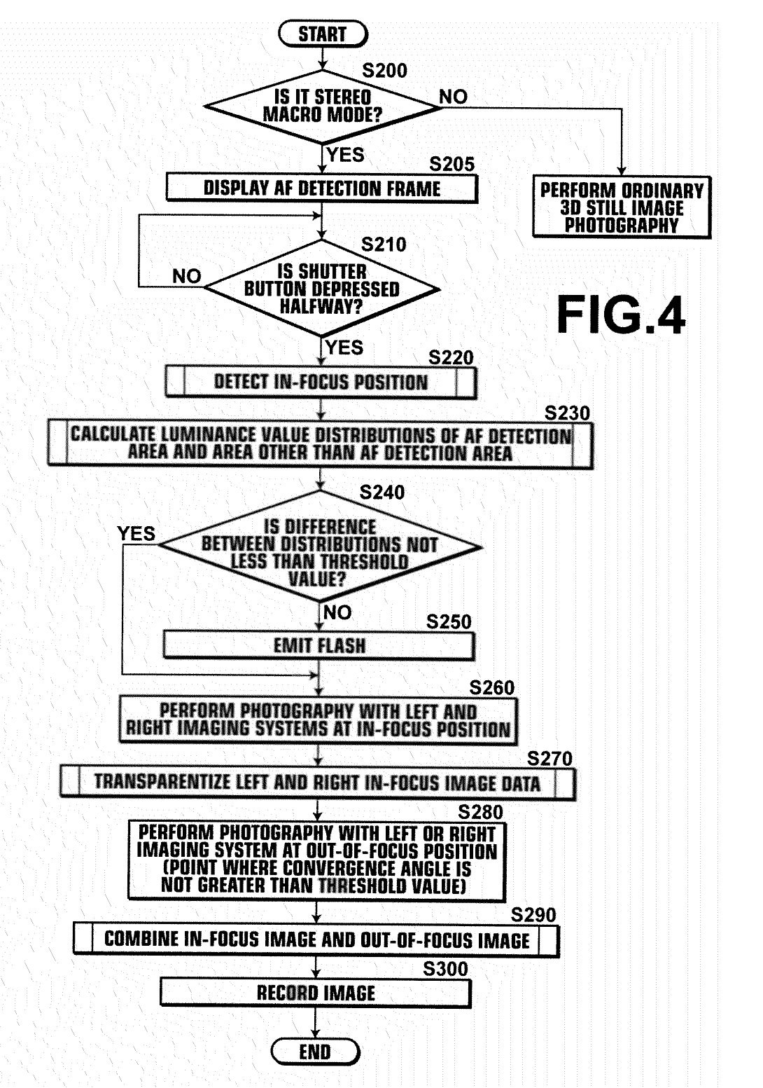

Hereinafter, processing performed by digital camera 1 at the time of macro photography will be described with reference to the flowchart in FIG. 4, illustrating a flow of the processing. Digital camera 1 of the present embodiment has two imaging systems, but the present invention is also applicable to a multiple eye photography apparatus having three or more imaging systems. Note that, in the description below, processing automatically performed by digital camera 1 is basically performed under control of CPU 110 unless otherwise specifically described.

First, the photography mode is set to Stereo Macro Mode by selecting “3D STILL IMAGE” by MODE dial 22 and setting MACRO button 36 to ON (S200 in FIG. 4). If MACRO button 36 is not set to ON, digital camera 1 is set to the ordinary 3D Still Image Photography Mode.

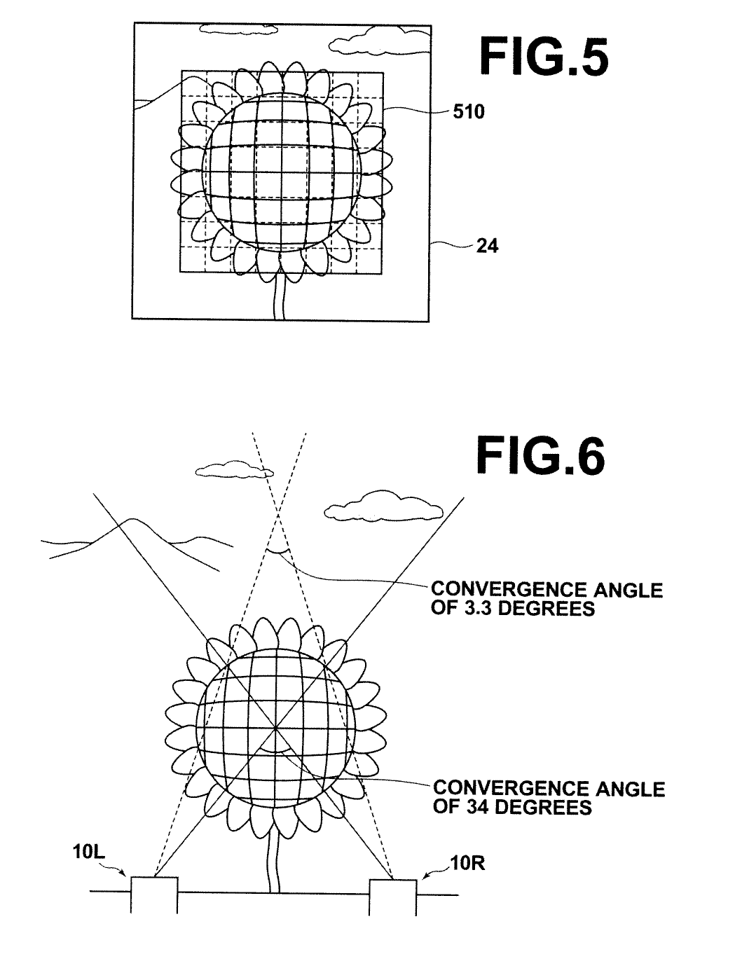

At this time, AF detection frame 510 like that shown in FIG. 5 is automatically displayed on monitor 24 (S205). AF detection frame 510 indicates a subject area to be focused, which may be set to any size by a photographer. In Stereo Macro Mode, AF detection is performed in the specified AF detection area.

Thereafter, when shutter button 18 is depressed halfway (S210), in-focus position is detected (S220). The in-focus position detection is based on a so-called contrast AF method and focusing is performed by moving focus lens 130F (FIG. 3) from an in-focus position in a near distance to an in-focus position in a far distance and detecting a peak position of contrast information detected by image sensor 134. More specifically, while moving focus lens 130F, image data are obtained at predetermined positions in order to detect a focusing state (sampling) at each position and the obtained image data are temporarily stored (buffering) in SDRAM 120.

Then, contrast information is obtained from image data obtained at each position and a focus position at which image data having maximum contrast information is obtained is detected as the in-focus position. In the present embodiment, detection of the in-focus position is performed by AF detection unit 144.

At the same time, the following are performed in digital signal processing unit 142 of right imaging system 10R or left imaging system 10L using the image data obtained for AF control. First, luminance value distribution (ZAF) in the AF detection area (area where a main subject is present) in AF detection frame 510 shown in FIG. 5 and luminance value distribution (NZ) in an area other than the AF detection area are calculated and the difference between them is obtained (S230). Then, flash emission control is performed by comparing the difference to a predetermined threshold in which flash non emission is selected if |ZAF−NZ|α, and flash emission is selected if |ZAF−NZ|<α (S240, S250). As for the calculation methods of the distribution (ZAF) and distribution (NZ), for example, Formulae (1) and (2) below may be used. Note that N in Formulae (1) and (2) below indicates the number of divided blocks. The divided block in Formula (2) is a divided block of the same size as that of the block in Formula (1) below.

$$ZAF = {σ}^{2} = ( 1 / {N}^{2} ) {\sum }_{x = 1}^{N} {( AFx - {μ}_{AF} )}^{2} \qquad ( 1 )$$

where, AFx is an average luminance value of a divided block (one of 64 divided blocks in FIG. 5) in AF detection area, and μ_{AF} is an average luminance value of the AF detection area.

$$NZ = {σ}^{2} = ( 1 / {N}^{2} ) {\sum }_{x = 1}^{N} {( NAFx - {μ}_{NAF} )}^{2} \qquad ( 2 )$$

where, NAFx is an average luminance value of a divided block outside of the AF detection area, and μ_{NAF} is an average luminance value outside of the AF detection area.

Further, with respect to the emission amount of a flash, if macro photography is performed with an emission amount of a flash for ordinary photography other than macro photography, halation occurs on the subject. Therefore, the flash is controlled so as to emit a smaller amount of light when digital camera 1 is set to Stereo Macro Mode by storing a light amount value smaller than the ordinary light amount in flash ROM 118 or the like of the camera. Alternatively, the relationship between the distribution difference described above and the emission amount of a flash may be preset and the flash may be emitted such that the smaller the difference the greater the amount of light.

Thereafter, when shutter button 18 is depressed fully, an image focused on a main subject is photographed (first photography) by each of right imaging system 10R and left imaging system 10L, and image data obtained thereby are temporarily stored in SDRAM 120. Note that, when the first photography is performed, if the condition of |ZAF−NZ|<α described above is satisfied, light is emitted onto the main subject from flash 16.

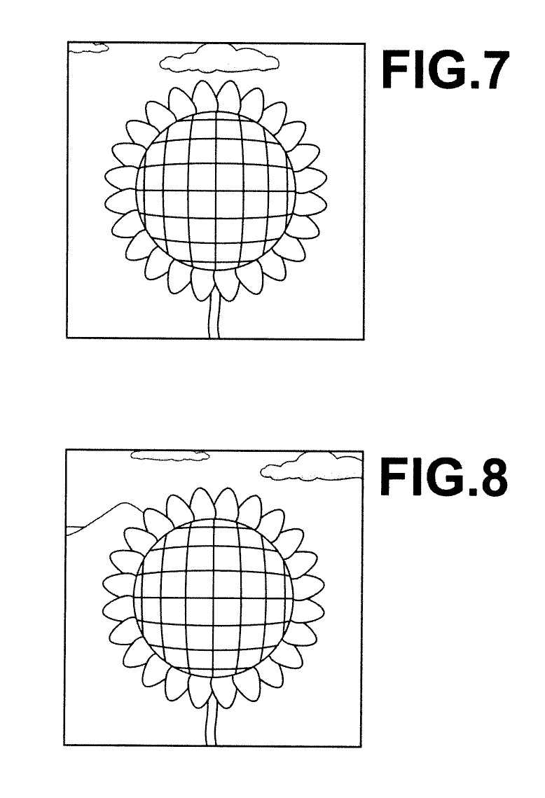

Images obtained by the first photography are shown in FIGS. 7 and 8 with a scene in FIG. 6 taking as an example. FIG. 7 shows an in-focus image obtained by left imaging system 10L in Macro Mode and FIG. 8 shows an in-focus image obtained by right imaging system 10R in Macro Mode. In Macro Mode, the distance between the optical axes of two taking lenses 14, 14 is set to about 6 cm as a distance which is most likely to provide the stereoscopic effect taking into account the physical size of the lenses and the parallax of human eyes. For example, if a flower like that shown in FIG. 6 at a distance of 10 cm from the lenses is the main subject, the convergence angle is about 34 degrees. Consequently, in this case, the mountain and cloud in the background of the main subject are shifted to left or right, which is the so-called reverse phase of background images.

Then, in order to extract only the main subject from such images, transparentizing processing, i.e., making 00 h in terms of the digital signal value is performed on an area other than the main subject (S270). The image processing for the transparentization is performed in image processing unit 170, shown in FIG. 3, having a program for executing the processing recorded therein.

A value serving as an index of performing the processing is the luminance distribution of image data of an in-focus image. That is, when obtaining an in-focus image, photographing has already been performed such that luminance values of main subject and of the area other than the main subject have a difference greater than a certain value, so that the area to be transparentized can be identified through a threshold judgment of the luminance distribution.

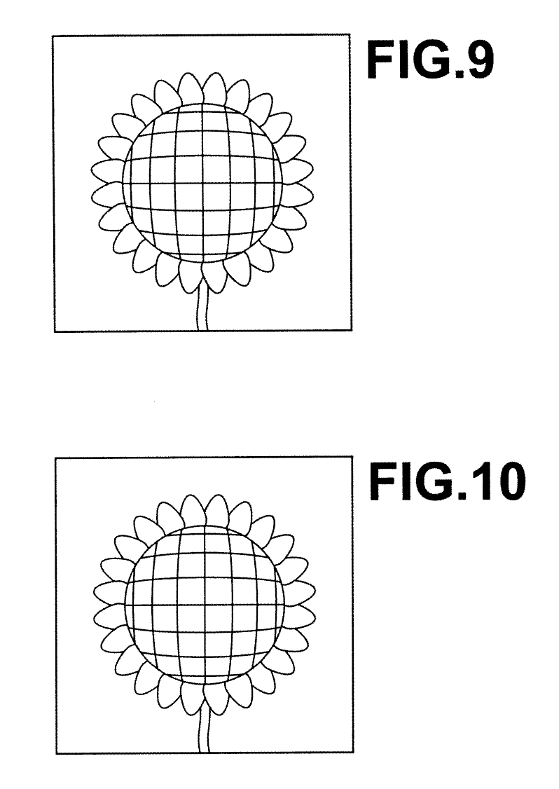

The transparentized images obtained from those of FIGS. 7 and 8 in the manner as described above are shown in FIGS. 9 and 10 respectively. As shown in FIG. 9 or 10, an image in which only the main subject of flower is extracted is obtained. The image processing for the transparentization is performed in the image processing unit 170 as described above. Alternatively, such a processing function may be provided in CPU 110 and performed therein. The image data subjected to the transparentizing processing are temporarily stored in SDRAM 120.

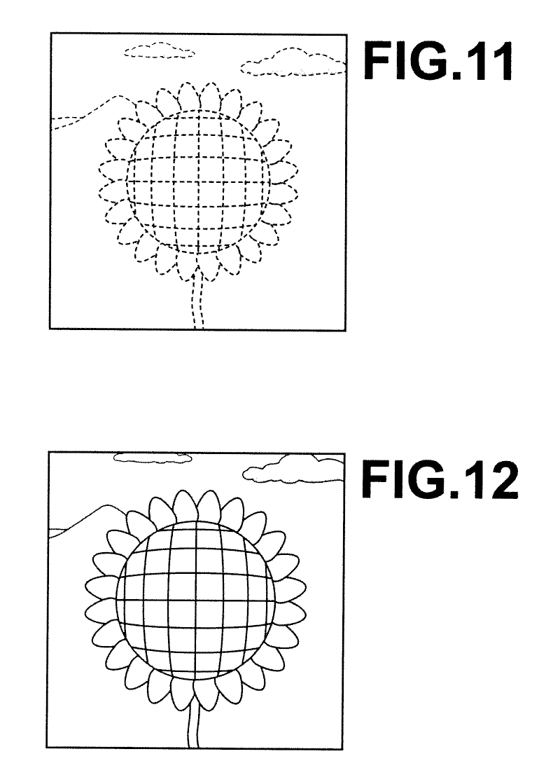

Thereafter, zoom lens 130Z of right imaging system 10R or left imaging system 10L is automatically set from the Macro Mode focus position to a position where the focus is on a position farther away than the main subject, for example, on a position about 1 m away from taking lens 14 (main subject out-of-focus position), and photography is performed under this state (second photography) (S280). The image photographed by left imaging system 10L or right imaging system 10R (out-of-focus image) is shown in FIG. 11. In this way, an image of the scene of FIG. 6 in which the focus is not at the “flower”, “mountains”, and “clouds” is obtained. Image data representing the out-of-focus image are also temporarily stored in SDRAM 120.

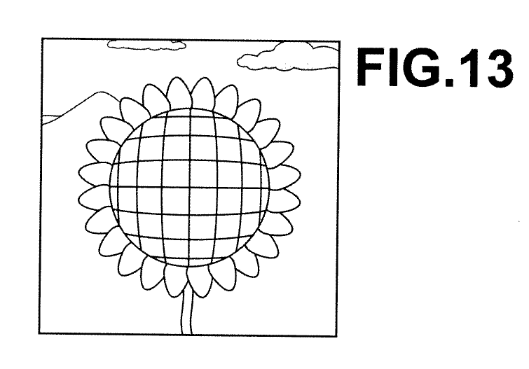

Then, processing for combining the transparentized images shown in FIGS. 9, 10 and out-of-focus image shown in FIG. 11 is performed using the image data stored in SDRAM 120 (S290). Here, only an area of the out-of-focus image corresponding to the transparentized area of each transparentized image is extracted and the extracted area and each transparentized image are combined. Here, the extraction processing is performed in image processing unit 170, shown in FIG. 3, having a program for executing the processing recorded therein, and the combining processing is performed by image combining unit 171. The combined images in the manner as described above are shown in FIGS. 12, 13. The background images of the two combined images are the same so that the reverse phase does not occur in the background.

Here, the sizes of the subjects in two images combined in the manner as described above differ from each other. Consequently, when combining the two images, the information (coordinate data within the image) of AF detection frame set when obtaining the Stereo Macro Mode in-focus image is used for aligning the two images, whereby a combined image that does not give uncomfortable feeling may be obtained.

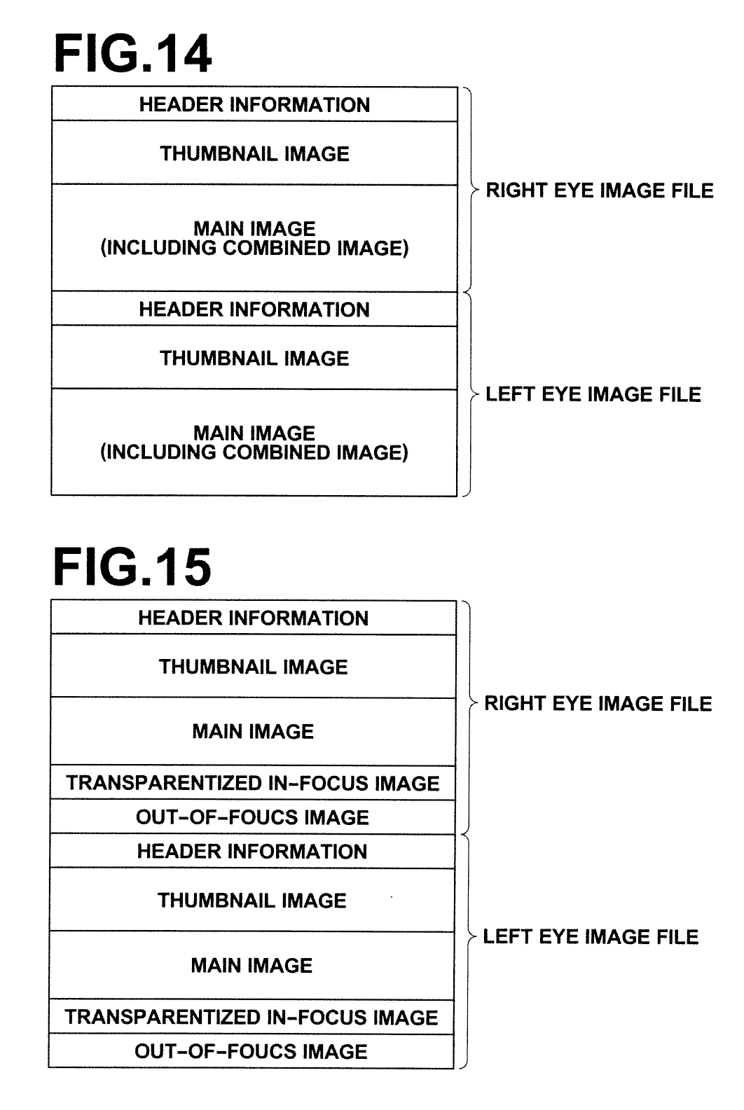

Then, image data representing the combined image are recorded in memory card 156 (S300). The recording format is shown in FIG. 14. As shown in FIG. 14, a right eye image file which includes image data of an image photographed by right imaging system 10R and a left eye image file which includes image data of an image photographed by left imaging system 10L are generated separately and stored in memory card 156.

More specifically, the right eye image file includes main image data which include a combined image corresponding to right imaging system 10R, thumbnail image data obtained by performing reducing processing on the combined image, and header information which includes information indicating that the image is a right eye image and information relating the main image data and thumbnail image data. The left eye image file includes main image data which include a combined image corresponding to left imaging system 10L, thumbnail image data obtained by performing reducing processing on the combined image, and header information which includes information indicating that the image is a left eye image and information relating the main image data and thumbnail image data.

The header information of the right eye image file includes information of left eye image file obtained at the same time with the main image data of the right eye image file, while header information of the left eye image file includes information of right eye image file obtained at the same time with the main image data of the left eye image file, whereby the right eye image file and left eye image file corresponding to each other are related via each header information.

Then, in Reproduction Mode, right eye and left eye image files corresponding to each other are read out based on the header information, and a stereoscopic image is generated based on these files and displayed on monitor 24. As for the method of generating the stereoscopic image, any known method may be used, as described above.

When a plurality of sets of right eye and left eye image files is recorded, a stereoscopic image of thumbnail images corresponding to each set of files may be generated based on thumbnail image data of each set of files and displayed on monitor 24 to accept selection of any one of the plurality of thumbnail images and a stereoscopic image may be displayed on monitor 24 based on the main image data of the set of files corresponding to the selected thumbnail image.

A recording format shown in FIG. 15 may also be used as an alternative recording format of the image data. In the format shown in FIG. 15, each of right eye and left eye image files further includes a “transparentized in-focus image” obtained by photographing in Stereo Macro Mode and performing image processing, and an “out-of-focus image”. Here, coordinate information of the AF detection frame and the like are recorded in the header information. The “out-of-focus images” in the right eye and left eye image files are the same.

In this case, a stereoscopic image may be obtained, in Reproduction Mode, by reading the transparentized in-focus image and out-of-focus image from each of the right eye and left eye image files, superimposing the images based on header information to generate a right eye combined image and a left eye combined image, and displaying the combined images on monitor 24.

Such recording format is, of course, applicable not only to recording macro photographed images but also to recording 3D still images photographed by other photography modes.

In the embodiment described above, a macro photographed image, which is one of the two images obtained by lenses having different focal lengths, is transparentized in an area other than the main subject and the transparentized image and the other image photographed by taking lens 14 with a longer focal length than that of the macro photographing are superimposed, so that a stereoscopic image that does not give uncomfortable feeling may be displayed or recorded without using any special device.

When photographing an image to be transparentized in an area other than the main subject, if a flash is emitted to intentionally increase the difference in luminance between the main subject and background, the focused main subject may be clearly identified and the range of transparetizing area may be appropriately determined.

In the first embodiment described above, an out-of-focus image is obtained using either one of the right imaging system 10R and left imaging system 10L. But an arrangement may be adopted in which second photographing is performed using the right imaging system 10R and left imaging system 10L, as in the manner described above, then either one of the two images obtained by the right imaging system 10R and left imaging system 10L is selected, and the selected image is obtained as the out-of-focus image. The selection of either one of the two images may be performed by the operator or automatically.

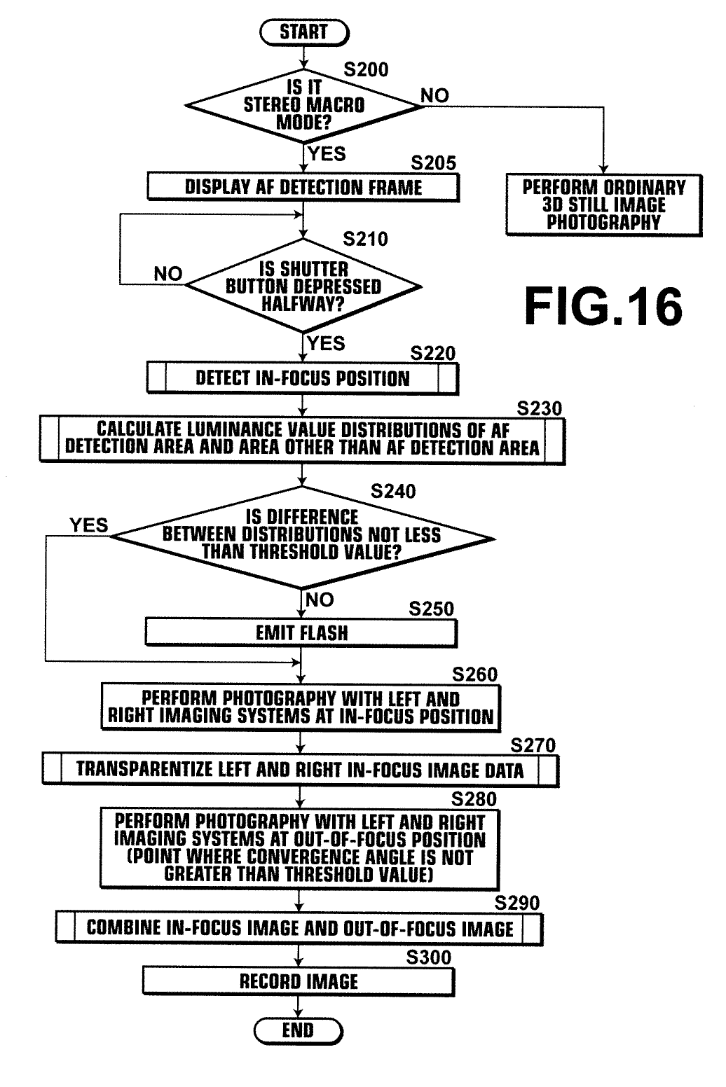

A digital camera that incorporates a second embodiment of the multiple eye photography apparatus of the present invention will now be described in detail. Whereas, in the digital camera according to the first embodiment, the same background image (out-of-focus image) is used in the two combined images, the digital camera according to the second embodiment generates combined images using out-of-focus images photographed by the two imaging systems in order to generate a stereoscopic image with higher realistic sensation. The schematic configuration of the digital camera according to the second embodiment is substantially identical to that of the digital camera according to the first embodiment. The digital camera according to the second embodiment differs from the digital camera according to the first embodiment only in the method of obtaining the out-of-focus image and the method of generating a combined image. Therefore, focusing on these points, the description will be made with reference to the flowchart shown in FIG. 16.

From the step of setting Stereo Macro Mode to the step of transparentizing processing (S200 to S270) are identical to steps S200 to 5270 of the digital camera according to the first embodiment shown in FIG. 4.

Then, after the transparentizing processing is performed on the in-focus image, zoom lens 130Z of each of right imaging system 10R and left imaging system 10L is automatically set from the Macro Mode focus position to a position where the focus is on a position farther than the main subject, for example, on a position about 1 m away from taking lens 14 (main subject out-of-focus position), and photographing is performed under this state (second photographing), and out-of-focus images are obtained (S280). The difference between the out-of-focus images photographed by left imaging system 10L and right imaging system 10R in terms of convergence angle is only about 3.3 degrees so that the reverse phase does not occur in the background images. Image data representing these images are also temporarily stored in SDRAM 120.

In the present embodiment, each zoom lens 130Z is automatically moved to a position where the focus is at a distance of 1 m, but the distance may be any distance as long as it is within the range in which the convergence angle does not cause a reverse phase in the background images. From the viewpoint of avoiding the reverse phase, a distance that forms a small convergence angle is desirable. Further, a defocused image is desirable as the background images. That is, it is preferable that subjects included in the background images, such as a “mountain” and a “cloud”, are out-of-focus. The reason is that, if the background includes a clear image, the eyes are brought to a focus on the background image when observing a stereoscopic image, thereby making it difficult to observe the stereoscopic image.

Then, processing for combining the transparentized image and out-of-focus image corresponding to right imaging system 10R and processing for combining the transparentized image and out-of-focus image corresponding to left imaging system 10L are performed using image data stored in SDRAM 120 (S290).

Here, the two images may be aligned using the information (coordinate data within the image) of AF detection frame set when obtaining the Stereo Macro Mode in-focus image, as in the digital camera according to the first embodiment.

Then, the combined images are stored in memory card 156 (S300). The recording format is similar to that of the first embodiment other than that the out-of-focus image in the right eye image file differs from the out-of-focus image in the left eye image file.

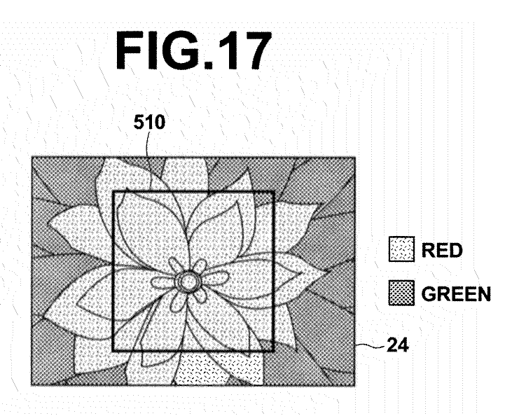

A digital camera that incorporates a third embodiment of the multiple eye photography apparatus of the present invention will now be described in detail. Whereas, the digital camera according to the first or second embodiment is capable of favorably performing stereo macro photography for a scene which includes both a near view and a distant view like that shown in FIG. 5, the digital camera according to the third embodiment is capable of favorably performing stereo macro photography even for a scene which includes only a near view like that shown in FIG. 17. The schematic configuration of the digital camera according to the third embodiment is substantially identical to that of the digital camera according to the first or second embodiment. The digital camera according to the third embodiment differs from the digital camera according to the first or second embodiment only in the photography control method. Therefore, the description will be made hereinafter focusing on this point. Note that operations of the digital camera of the present embodiment identical to the operations of the digital camera of the first or second embodiment will not be elaborated upon further here unless otherwise required.

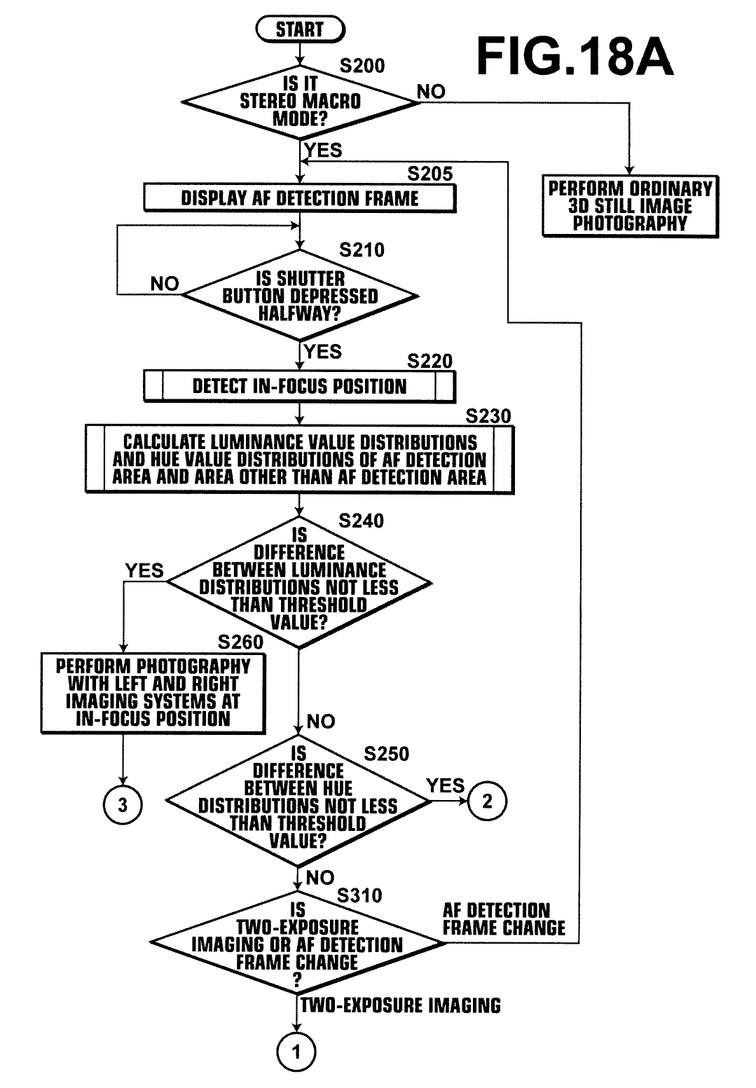

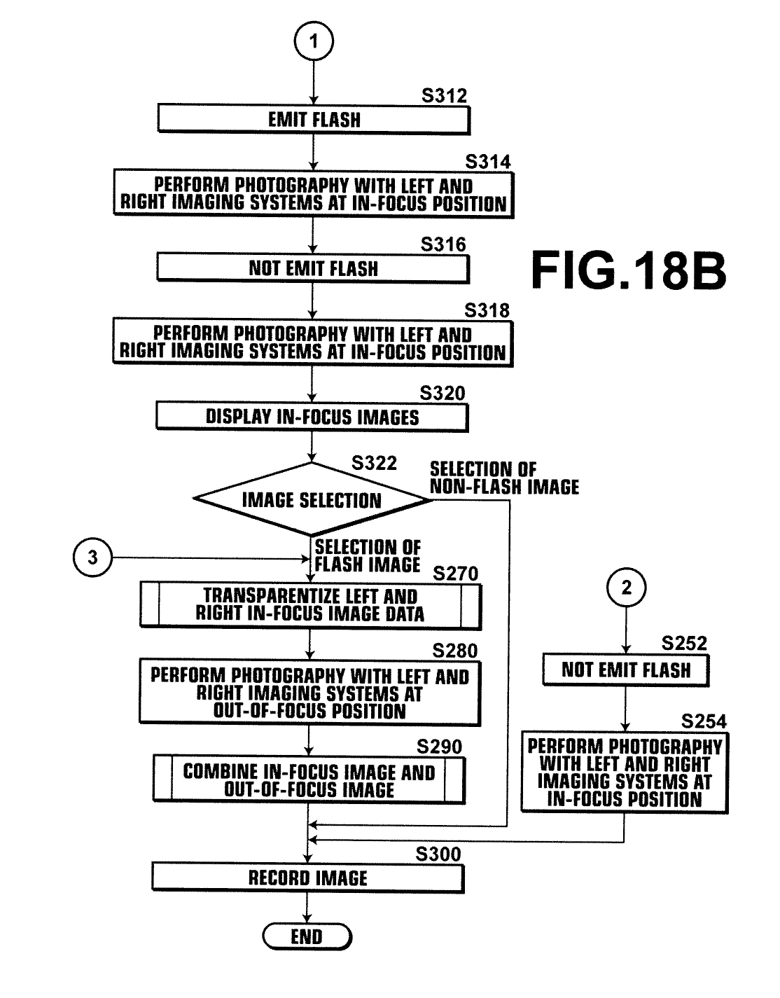

Now, with reference to the flowchart shown in FIGS. 18A and 18B, processing performed, when stereo macro photography is performed, by the digital camera according to the third embodiment will be described.

First, the photography mode is set to Stereo Macro Mode by selecting “3D STILL IMAGE” by MODE dial 22 and setting MACRO button 36 to ON (S200 in FIG. 4), as in the digital camera of the first or second embodiment (S200). Then, AF detection frame 510 like that shown in FIG. 17 is displayed on monitor 24 (S205).

Then, shutter button 18 is depressed halfway (S210) and in-focus position is detected (S220).

At the same time, the following are performed in digital signal processing unit 142 of right imaging system 10R or left imaging system 10L using image data obtained for AF control. First, luminance value distribution (ZAF) in the AF detection area in AF detection frame 510 shown in FIG. 17 and luminance value distribution (NZ) in an area other than the AF detection area are calculated and the difference between them is obtained. In addition, hue value distribution (CAF) in the AF detection area in AF detection frame 510 shown in FIG. 17 and hue value distribution (NC) in an area other than the AF detection area are calculated and the difference between them is obtained (S230). The methods of calculating the distribution (ZAF) and distribution (NZ) are identical to those in the embodiments described above. As for the calculation methods for the distribution (CAF) and distribution (NC), for example, Formulae (3) and (4) below may be used. Note that N in Formulae (3) and (4) below indicates the number of divided blocks. The divided block in Formula (4) is a divided block of the same size as that of the block in Formula (3) below.

$$CAF = {σ}^{2} = ( 1 / {N}^{2} ) {\sum }_{x = 1}^{N} {( AFx - {μ}_{AF} )}^{2} \qquad ( 3 )$$

where, AFx is an average hue value of a divided block (one of 64 divided blocks in FIG. 5) in AF detection area, and μ_{AF} is an average hue value of the AF detection area.

$$NC = {σ}^{2} = ( 1 / {N}^{2} ) {\sum }_{x = 1}^{N} {( NAFx - {μ}_{NAF} )}^{2} \qquad ( 4 )$$

where, NAFx is an average hue value of a divided block outside of the AF detection area, and μ_{NAF} is an average hue value outside of the AF detection area.

Next, a comparison is made between the difference in luminance value distribution and a predetermined threshold value (α), and if |ZAF−NZ|≧α (S240, YES), flash non-emission control is performed and operations in steps S200 to 5300 are performed, as in the digital camera of the first embodiment. The operations of steps S260 to S300 shown in FIGS. 18A, 18B are identical to those of steps S260 to S300 shown in FIG. 4.

In the mean time, if the comparison result of the difference in luminance value distribution with the predetermined threshold value (α) in step S240 is |ZAF−NZ|<α, a comparison is made between the difference in hue value distribution and a predetermined threshold value (β). If |CAF−NC|≧β (S250, YES), that is, if nearly all images photographed are near view images and the color variation of the image in AF detection frame 510 and the color variation of the image other than the image in AF detection frame 510 are different, as shown in FIG. 17, flash non-emission control is performed (S252). Thereafter, when shutter button 18 is depressed fully, an image focused on a main subject is photographed (first photography) by each of right imaging system 10R and left imaging system 10L. Image data obtained by the first photography are stored in memory card 156 without being subjected to the transparentizing processing (S300). Then, in Reproduction Mode, the in-focus image obtained by each of right imaging system 10R and left imaging system 10L is read out, and a stereoscopic image is generated based on these images and displayed on monitor 24.

Ordinary macro photographing without a flash in the manner as described above may prevent halation from occurring on the main subject. Further, in this case, a background scene may be considered not to present so that the transparentizing processing and combining processing described above are not performed. That is, the convergence angle here is also about 34 degrees described above, but no background scene is present and hence the reverse phase problem does not occur, so that in-focus images obtained are recorded as they are without being subjected to the transparentizing processing, and displayed.

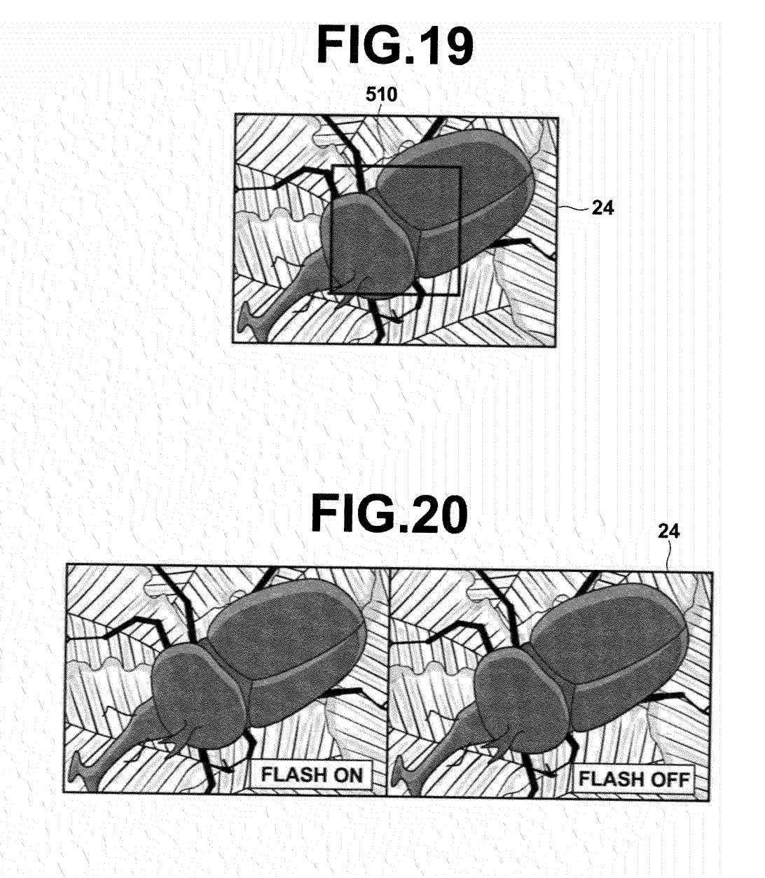

In the mean time, if the comparison result of the difference in hue value distribution with the predetermined threshold value (13) in step S250 is |CAF−NC|<β (S250, NO), that is, as shown in FIG. 19, nearly all images photographed are near view images but the color variation of the image (beetle) in AF detection frame 510 and the color variation of the image (dead leaves) other than the image in AF detection frame 510 are identical, a screen for selecting performance of two-exposure imaging or change of AF detection frame (AF detection area) is displayed on monitor 24 (S310). The “two-exposure imaging” is a method in which in-focus image photography with a flash and in-focus image photography without a flash are performed and, thereafter, selection of either one of the in-focus images is accepted, as described later.

Then, in step S310, if the change of AF detection frame 510 (AF detection area) is selected by the operator, AF detection frame 510 (AF detection area) is changed by the operator or automatically and the processing steps from S205 onward are performed again. When AF detection frame 510 (AF detection area) is changed automatically, it is not known that in what situation the main subject is in with respect to AF detection frame, so that processing steps from S205 onward are repeated by increasing or decreasing the AF detection frame, whereby the difference between the luminance value distribution in the AF detection frame and luminance value distribution other than in the AF detection frame or the difference between the hue value distribution in the AF detection frame and hue value distribution other than in the AF detection frame is adjusted to become greater or equal to a predetermined threshold value. The adjustment in the manner described above allows discrimination between the main subject and background portion regardless of the size of the main subject on monitor 24 or even when the color difference between the main subject and background portion is small.

In the mean time, if the two-exposure imaging is selected in step S310, thereafter, when shutter button 18 is depressed fully, an in-focus image is photographed by each of right imaging system 10R and left imaging system 10L under flash emission control (S312, S314). Then, an in-focus image is further photographed by each of right imaging system 10R and left imaging system 10L under flash non-emission control (S316, S318).

Then, an in-focus image photographed under flash emission control and an in-focus image photographed under flash non-emission control are displayed on monitor 24, as shown in FIG. 20. Here, monitor 24 may be configured to display a stereoscopic image generated based on the in-focus images photographed by right imaging system 10R and left imaging system 10L or to display either one of the in-focus images photographed by right imaging system 10R and left imaging system 10L.

Then, either one of the in-focus image with a flash and in-focus image without a flash displayed on monitor 24 is selected by the operator (S322).

If the in-focus image without a flash is selected, the in-focus image photographed without a flash is recorded in memory card 156 (S300). Then, in Reproduction Mode, the in-focus images photographed by right imaging system 10R and left imaging system 10L are read out, and a stereoscopic image is generated based on the in-focus images and displayed on monitor 24.

On the other hand, if the in-focus image with a flash is selected in step S322, transparentizing processing is performed on the in-focus image data (S270), and then an out-of-focus image is photographed by each of right imaging system 10R and left imaging system 10L (S280), then the in-focus and out-of-focus images are combined to generate a combined image (S290), and the combined image data are recorded (S300). Then, in Reproduction Mode, the combined image obtained by each of right imaging system 10R and left imaging system 10L is read out and a stereoscopic image is generated based on the combined images and displayed on monitor 24.

As described above, in the present invention, a stereo macro photography is performed by determining as to whether or not the emission of a flash, image transparentization, and image combining are performed based on the case in which a main subject and a distant view are included in the field and the case in which only a near view main subject is included in the field. This allows a favorable stereoscopic image to be photographed according to the photograph scene.

What is claimed is:

1. A multiple eye photography method for use when macro photography is performed by a multiple eye photography apparatus having a plurality of imaging systems, the method comprising the steps of:
performing first macro photography with each of the imaging systems being focused on a main subject to obtain first images;
performing second photography with one of the plurality of imaging systems being focused on a position farther away than the main subject to obtain a second image;
performing processing on each of the first images to transparentize an area other than the main subject; and
combining each of the transparentized first images and an area other than the main subject of the second image to generate a combined image corresponding to each of the imaging systems.

2. A multiple eye photography method for use when macro photography is performed by a multiple eye photography apparatus having a plurality of imaging systems, the method comprising the steps of:
performing first macro photography with each of the imaging systems being focused on a main subject to obtain first images;
obtaining, as a second image, one of images obtained through second photography performed with each of the plurality of imaging systems being focused on a position farther away than the main subject;
performing processing on each of the first images to transparentize an area other than the main subject; and
combining each of the transparentized images and an area other than the main subject of the second image to generate a combined image corresponding to each of the imaging systems.

3. A multiple eye photography method for use when macro photography is performed by a multiple eye photography apparatus having a plurality of imaging systems, the method comprising the steps of:
performing first macro photography with each of the imaging systems being focused on a main subject to obtain first images;
performing second photography with each of the plurality of imaging systems being focused on a position farther away than the main subject to obtain second images;
performing processing on each of the first images for transparentizing an area other than the main subject; and
combining each of the transparentized images and an area other than the main subject of each of the second images corresponding to each of the first images to generate a combined image corresponding to each of the imaging systems.

4. A multiple eye photography apparatus, comprising:
a plurality of imaging systems;
an imaging system controller for controlling each of the imaging systems to perform first macro photography with each of the imaging systems being focused on a main subject and to perform second photography with one of the plurality of imaging systems being focused on a position farther away than the main subject;
a transparentizing processing unit for performing processing on each of first images obtained by each of the imaging systems through the first macro photography for transparentizing an area other than the main subject; and
a combined image generation unit for combining each of the transparentized first images transparentized by the transparentizing processing unit and an area other than the main subject of the second image to generate a combined image corresponding to each of the imaging systems.

5. A multiple eye photography apparatus comprising:
a plurality of imaging systems,
an imaging system controller for controlling each of the imaging systems to perform first macro photography with each of the imaging systems being focused on a main subject and to perform second photography with each of the imaging systems being focused on a position farther away than the main subject;
a transparentizing processing unit for performing processing on each of first images obtained by each of the imaging systems through the first macro photography to transparentize an area other than the main subject; and
a combined image generation unit for combining each of the transparentized first images transparentized by the transparentizing processing unit and an area other than the main subject of a second image which is one of the images obtained by each of the imaging systems through the second photography to generate a combined image corresponding to each of the imaging systems.

6. A multiple eye photography apparatus, comprising:
a plurality of imaging systems,
an imaging system controller for controlling each of the imaging systems to perform first macro photography with each of the imaging systems being focused on a main subject and to perform second photography with each of the imaging systems being focused on a position farther away than the main subject;
a transparentizing processing unit for performing processing on each of first images obtained by each of the imaging systems through the first macro photography to transparentize an area other than the main subject; and
a combined image generation unit for combining each of the transparentized first images transparentized by the transparentizing processing unit and an area other than the main subject of each of second images, corresponding to each of the first images, obtained by each of the imaging systems through the second photography to generate a combined image corresponding to each of the imaging systems.

7. The multiple eye photography apparatus of claim 4, further comprising a flash controller for emitting a flash when discrimination between a predetermined area, including the main subject, and an area other than the predetermined area within a photograph range of each of the imaging systems is difficult at the time of the first macro photography.

8. The multiple eye photography apparatus of claim 5, further comprising a flash controller for emitting a flash when discrimination between a predetermined area, including the main subject, and an area other than the predetermined area within a photograph range of each of the imaging systems is difficult at the time of the first macro photography.

9. The multiple eye photography apparatus of claim 6, further comprising a flash controller for emitting a flash when discrimination between a predetermined area, including the main subject, and an area other than the predetermined area within a photograph range of each of the imaging systems is difficult at the time of the first macro photography.

10. The multiple eye photography apparatus of claim 7, wherein:
the apparatus further comprises a luminance distribution detection unit for detecting a luminance value distribution of the predetermined area, including the main subject, and a luminance value distribution of the area other than the predetermined area within the photograph range of each of the imaging systems; and
the flash controller is a controller that, when the first macro photography is performed, does not emit a flash if the difference between the distributions is greater than or equal to a threshold value and emits a flash if the difference between the distributions is smaller than the threshold value.

11. The multiple eye photography apparatus of claim 8, wherein:
the apparatus further comprises a luminance distribution detection unit for detecting a luminance value distribution of the predetermined area, including the main subject, and a luminance value distribution of the area other than the predetermined area within the photograph range of each of the imaging systems; and
the flash controller is a controller that, when the first macro photography is performed, does not emit a flash if the difference between the distributions is greater than or equal to a threshold value and emits a flash if the difference between the distributions is smaller than the threshold value.

12. The multiple eye photography apparatus of claim 9, wherein:
the apparatus further comprises a luminance distribution detection unit for detecting a luminance value distribution of the predetermined area, including the main subject, and a luminance value distribution of the area other than the predetermined area within the photograph range of each of the imaging systems; and
the flash controller is a controller that, when the first macro photography is performed, does not emit a flash if the difference between the distributions is greater than or equal to a threshold value and emits a flash if the difference between the distributions is smaller than the threshold value.

13. The multiple eye photography apparatus of claim 4, further comprising:
a hue distribution detection unit for detecting a hue value distribution of a predetermined area, including the main subject, and a hue value distribution of an area other than the predetermined area within a photograph range of each of the imaging systems; and
a photography & processing controller for performing control such that:
if the difference between the distributions is greater than or equal to a threshold value, the first macro photography is performed only without a flash; while
if the difference between the distributions is smaller than the threshold value, the first macro photography is performed with and without a flash, selection of either one of the first images obtained by the first macro photography with and without a flash is accepted, the selected first image is subjected to the transparentizing processing, and the combined image is generated using the transparentized first image and the second image.

14. The multiple eye photography apparatus of claim 5, further comprising:
a hue distribution detection unit for detecting a hue value distribution of a predetermined area, including the main subject, and a hue value distribution of an area other than the predetermined area within a photograph range of each of the imaging systems; and
a photography & processing controller for performing control such that:
if the difference between the distributions is greater than or equal to a threshold value, the first macro photography is performed only without a flash; while
if the difference between the distributions is smaller than the threshold value, the first macro photography is performed with and without a flash, selection of either one of the first images obtained by the first macro photography with and without a flash is accepted, the selected first image is subjected to the transparentizing processing, and the combined image is generated using the transparentized first image and the second image.

15. The multiple eye photography apparatus of claim 6, further comprising:
a hue distribution detection unit for detecting a hue value distribution of a predetermined area, including the main subject, and a hue value distribution of an area other than the predetermined area within a photograph range of each of the imaging systems; and
a photography & processing controller for performing control such that:
if the difference between the distributions is greater than or equal to a threshold value, the first macro photography is performed only without a flash; while
if the difference between the distributions is smaller than the threshold value, the first macro photography is performed with and without a flash, selection of either one of the first images obtained by the first macro photography with and without a flash is accepted, the selected first image is subjected to the transparentizing processing, and the combined image is generated using the transparentized first image and the second image.

16. A computer readable recording medium on which is recorded a program for causing a computer to perform a multiple eye photography method for use when macro photography is performed by a multiple eye photography apparatus, the method comprising the steps of:
performing first macro photography with each of the imaging systems being focused on a main subject to obtain first images;
performing second photography with one of the plurality of imaging systems being focused on a position farther away than the main subject to obtain a second image;
performing processing on each of the first images to transparentize an area other than the main subject; and
combining each of the transparentized first images and an area other than the main subject of the second image to generate a combined image corresponding to each of the imaging systems.

17. A computer readable recording medium on which is recorded a program for causing a computer to perform a multiple eye photography method for use when macro photography is performed by a multiple eye photography apparatus, the method comprising the steps of:
performing first macro photography with each of the imaging systems being focused on a main subject to obtain first images;
obtaining, as a second image, one of images obtained through second photography performed with each of the plurality of imaging systems being focused on a position farther away than the main subject;
performing processing on each of the first images to transparentize an area other than the main subject; and
combining each of the transparentized images and an area other than the main subject of the second image to generate a combined image corresponding to each of the imaging systems.

18. A computer readable recording medium on which is recorded a program for causing a computer to perform a multiple eye photography method for use when macro photography is performed by a multiple eye photography apparatus, the method comprising the steps of:
performing first macro photography with each of the imaging systems being focused on a main subject to obtain first images;
performing second photography with each of the plurality of imaging systems being focused on a position farther away than the main subject to obtain second images;
performing processing on each of the first images for transparentizing an area other than the main subject; and
combining each of the transparentized images and an area other than the main subject of each of the second images corresponding to each of the first images to generate a combined image corresponding to each of the imaging systems.
